(19) United States
(12) Patent Application Publication
(10) Pub. No.: US 2024/0428757 A1
(43) Pub. Date: Dec. 26, 2024

(54) THUMB REST FOR A WIND INSTRUMENT

(71) Applicant: Arne Siebling, Kassel (DE)

(72) Inventor: Arne Siebling, Kassel (DE)

(21) Appl. No.: 18/752,926

(22) Filed: Jun. 25, 2024

(30) Foreign Application Priority Data
Jun. 25, 2023 (EP) 23181328.8

(51) Int. Cl. G10D 9/00

(52) U.S. Cl. CPC G10D 9/00

(57) ABSTRACT

A thumb rest for a wind instrument, in particular a clarinet, includes an adapter to attach the thumb rest to a body of the wind instrument, a support piece arranged at the adapter or supported thereby and a thumb stop that is arranged at the support piece. The thumb stop and the support piece are connected to one another in an articulated manner by a joint by which a permanent degree of rotational freedom of the thumb stop with respect to the support piece is provided so that the thumb stop is permanently rotatable with respect to the support piece.

### CROSS-REFERENCE TO RELATED APPLICATIONS

This application claims priority to European application number EP23181328.8, filed Jun. 25, 2023, which is hereby incorporated by reference in its entirety.

### FIELD OF THE INVENTION

The invention relates to a thumb rest for a wind instrument, and to a wind instrument having a body and a thumb rest, and to a use of a thumb rest for playing a wind instrument having the disclosed features.

### BACKGROUND OF THE INVENTION

A thumb rest for a clarinet is known from the document DE 41 13 871 C2 that has a receiving sleeve screwed to the clarinet and a support piece that is received in the sleeve and at which a thumb stop is arranged that is supported on the thumb of the player when playing the clarinet. The thumb rest has various degrees of freedom to be able to optimally adapt the thumb rest to the player: It can be moved in the longitudinal direction of the clarinet, it can be rotated about the longitudinal direction of the clarinet, and a ball joint is provided so that the orientation of the thumb stop can be changed. The thumb rest can thus be optimally set in accordance with the wishes of the player before the actual playing and can be fixed therein.

With the thumb rest known from document U.S. Pat. No. 4,348,935 A, it is likewise possible for a player to adjust the thumb rest and to fix it in the desired position prior to the playing. An adjustment possibility of the thumb support in the longitudinal direction of the wind instrument is provided for this purpose. The thumb support can additionally be rotated about an axis of rotation that extends in parallel with the longitudinal axis of the wind instrument and that is pre-defined by a sleeve receiving the thumb support.

### SUMMARY OF THE INVENTION

It is the object of the invention to provide a thumb rest for a wind instrument that enables a playing of the wind instrument that is as comfortable as possible.

The object in accordance with the invention is achieved by a thumb rest having the features disclosed herein, by a wind instrument having such a thumb rest and having the features disclosed herein, and by a use of a thumb rest in accordance with the features disclosed herein.

The invention is based on the recognition that the orientation and location of the thumb rest can admittedly be set optimally for the player in advance with thumb rests known from the prior art. Particularly when playing the wind instrument for a fairly long time, fatigue and stiffness phenomena and/or an unpleasant pressure feeling may nevertheless occur. It is therefore proposed in accordance with the invention to design the thumb rest as variable as possible, in particular also during playing, for a position that is as variable as possible, but is nevertheless stabilized.

A thumb rest for a wind instrument in accordance with the invention has an adapter with which the thumb rest can be fastened to the wind instrument and in particular to its body. The adapter can e.g. be plugged or clipped onto the wind instrument. Further possibilities include screwing the adapter to the body or fastening it thereto with material continuity, for example by adhesive bonding or by soldering to existing metallic parts of the body.

The thumb rest furthermore has a support piece and a thumb stop arranged at the support piece. The support piece can be formed integrally by the adapter. Typically, however, it is a separate component that is fastened to the adapter during playing, with the fastening, however, being able to be releasable, e.g. to be able to set the position and orientation of the support piece and of the thumb stop fastened thereto prior to the playing.

The thumb stop is in contrast-unlike the thumb rests known from the prior art—connected to the support piece permanently and thus, in particular also during the playing, movably. A joint is provided for this purpose by which the thumb stop is connected to the support piece in an articulated manner. The joint is formed here such that one or also more degrees of freedom provided by the joint are also maintained during the playing. In other words, the joint cannot be locked with the thumb rest, in accordance with the invention. I.e. the joint does not serve to be able to set an individual, but then fixed, playing position. The movability between the thumb stop and the support piece achieved by the joint is rather maintained permanently and in particular during the playing. It can thus be achieved that the thumb stop remains permanently rotatable with respect to the support piece via a rotation zone predefined by the joint. The rotation zone here typically comprises an angular range of some degrees or even also of some tens of degrees. No one-sided playing posture thus results for the player when playing the wind instrument, but rather a constantly changing playing posture and thus also a varying strain on the thumb.

Keeping the joint permanently movable during playing can be achieved in a variety of manners, e.g. by an anchorage and a freely movable support of a joint head in a pivot joint housing. A further example is the configuration of the joint as a kind of film hinge composed of an elastic material. To name only one further example, a joint head can be clampingly gripped between two support surfaces, with the support surfaces being able to be tensioned with respect to one another up to a limited degree so that the joint head remains permanently movable held between the support surfaces.

The thumb rest in accordance with the invention can in particular be used with wind instruments whose bodies are above all held substantially in a vertical position during playing, such as a clarinet or an oboe. To be able to comfortably support the weight of the wind instrument, a thumb rest is helpful whose thumb stop is oriented substantially transversely to the weight force acting vertically downwardly. The transversely oriented thumb stop of the thumb rest lies on the thumb such that a slipping down of the wind instrument is prevented. In this respect, a large portion of the weight is borne by the thumb via the thumb rest and the player requires less power to clamp the wind instrument tightly between his fingers.

In accordance with an embodiment, the joint is configured as a pivot joint that has exactly one axis of rotation. This is already sufficient for a varied holding of the wind instrument during playing. However, a plurality of degrees of rotational freedom can also be provided by the joint by which the thumb stop is movably connected to the support piece. The joint can e.g. be configured as a ball joint having a plurality of axes of rotation about which the thumb stop can be rotated with respect to the support piece.

When the thumb rest is mounted on a wind instrument, the or one of the axes of rotation of the joint is in particular oriented substantially perpendicular to the longitudinal direction of the body of the wind instrument and substantially radially to its circular cross-section. With a clarinet, the thumb rest is typically mounted such that the thumb stop is located on the side of the body of the clarinet disposed opposite the keys. When the axis of rotation is oriented radially to the cross-section of the body, this means that the clarinet can oscillate to and fro slightly to the left and to the right lying on the thumb of the player. It can, however, for example, not oscillate, or can only oscillate to a limited degree freely to the front and to the back. This could be unfamiliar, or also unwanted, for a player since the required compensation movement with the fingers could have an influence on the force when gripping the keys. I.e. with the proposed orientation of the thumb rest and orientation of the axis of rotation, a flexible playing posture results for the player without impairing the playing itself, however. The or at least one axis of rotation can, however, also have any other orientation, with it preferably being oriented laterally to the circular cross-section of the body.

The joint can generally have any desired design. As explained above, it can be a pivot joint or a ball joint, with the joint being able to be implemented in different manners. The joint can be formed fully or partially integrally by the thumb stop and the support piece. The thumb stop can specifically be rotatably arranged at the support piece.

When the support piece and the thumb stop have support surfaces that are formed complementarily to one another, a particularly good support of the thumb stop at the support piece can be achieved, which contributes to a movability of the thumb stop with respect to the support piece that is as good as possible and is also well guided. The support surface of the thumb stop is e.g. formed convexly thereto while the complementary support surface of the support piece is concave with a corresponding radius of curvature. Conversely, the support surface of the support piece can also be convex, while that of the thumb stop is concave.

In accordance with an embodiment, the thumb stop has a cutout, with a shaft of the joint extending into the cutout or through the cutout so that the thumb stop is rotatably supported at the shaft. The shaft of the joint here defines the axis of rotation about which the thumb stop is rotatable.

The shaft can be formed integrally by the support piece. The shaft can have a termination piece to anchor the thumb stop to the shaft. To name only a few examples, the termination piece can be a thicker section at an end of the shaft projecting through the cutout of the thumb stop or can be a nut screwed to the end side or a cap placed onto the end side. The thumb stop can also be clipped onto the shaft of the support piece, with a slipping off from the shaft being able to be prevented by a termination piece.

Alternatively, the shaft of the joint can be formed integrally by the thumb stop, with the shaft e.g. being received rotatably in a mount of the support piece. For this purpose, the shaft can have a spherical end section that is clipped in a spherical mount of the support piece. A further possibility is that the thumb stop has a pin-shaped shaft that extends through a passage cutout of the support piece and is anchored therein by a nut screwed on at the end side or by another termination piece.

The shaft of the joint can also be formed separately from the thumb stop and the support piece. The joint can e.g. comprise a screw or a bolt. The shaft of the screw or of the bolt here represents the shaft of the joint at which the thumb stop is rotatably supported about the axis of rotation defined by the shaft. The screw or the bolt can be screwed into a corresponding thread in a cutout of the support piece for the connection to the support piece. The thumb stop can be rotatably captured between the head and the support piece by a head of the screw or of the bolt and can thus be securely held at the support piece.

The joint can be configured such that a smooth movement of the rotation of the thumb stop can be set with respect to the support piece. A player can thus himself define the degree to which the thumb stop should be movable. When the thumb stop is e.g. held between a termination piece (such as a screw head or bolt head) and the support piece, how smooth the thumb stop can be rotated can be set by a pressing force applied to the support piece by the termination piece. The pressing force can be varied, for example, in that the position of the termination piece is changed (e.g. by screwing in or unscrewing the screw/bolt). A spring or an elastic buffer element can also be provided that acts on the thumb stop and presses it against a support surface of the support piece. The resulting pressing force and thus the smoothness of the rotation can be set by compressing or relieving the spring or the buffer element.

To fasten the thumb rest to the wind instrument and in particular to its body, the adapter can be tightly clamped to the body and/or can be connected thereto with material continuity. The adapter can, for example, have a collar that can grip around the body and can thus clampingly grip around it for the tight clamping. A fastening with material continuity can be achieved by an adhesive bonding or tight screwing of the adapter to the body. A further possibility comprises fastening the adapter to a metallic component that is anyway present, e.g. by soldering. Such a component can e.g. be a metal ring of a gripping system or a metal ring in the region of a connection section of different parts of the body. The advantage of e.g. soldering to such a metal ring is that this kind of connection has no influence on the sound forming components of the wind instrument. The sound of the wind instrument is thus not influenced or is hardly influenced.

The optimum position and orientation of the thumb rest and of the thumb stop depends on the individual needs of the player, with these also being able to change over time. It can therefore be desirable not to fix the position and orientation for the player on the initial assembly, but rather also to be able to subsequently flexibly adapt it.

Provision is therefore made in accordance with an embodiment that the support piece is displaceably received in a mount formed by the adapter so that the support piece can be displaced—in the state of the thumb rest mounted on the wind instrument—in the longitudinal direction of the body of the wind instrument, at least to the specified extent. The position of the support piece and thus of the thumb stop can thus be set in the longitudinal direction of the body and can be fixed in the position desired by the player. If the position is to be subsequently changed, the fastening between the support piece and the adapter can be released again so that the support piece can be displaced in the longitudinal direction with respect to the adapter and the fastening can be fixed again. A screw that clampingly fixes the support piece in the mount formed by the adapter can e.g. serve the releasable fastening.

The mount formed by the adapter can, as a further aspect, be of a sleeve type having an annular free mount cross-section. If the support piece is of pin form having a cross-section complementary to the annular mount cross-section, the support piece can be rotatably received in the mount. I.e. the support piece (and thus also the thumb stop connected thereto) can be moved up and down with respect to the adapter, not only in the longitudinal direction, to set the optimum position for the player. The support piece and thus also the thumb stop can rather be rotated with respect to the mount or the adapter about the axis of rotation that is defined by the mount and that is substantially in parallel with the longitudinal axis of the body. The angular range in which the thumb stop projects from the body can thus be set. If a player has set the optimum position, this setting can be fixed e.g. by a screwing tight of a screw.

The solution in accordance with the invention further relates to a wind instrument, in particular to a clarinet, having a body of a thumb rest in accordance with the invention fastened to the body. The thumb rest can be permanently fastened to the body by means of the adapter at the wind instrument, e.g. by a soldered connection between the adapter and a metallic component such as a metal ring provided at the body. The statements on the thumb rest in accordance with the invention apply with respect to further exemplary embodiments.

The invention also relates to the use of a thumb rest for a wind instrument that has an adapter to attach the thumb rest to the body of the wind instrument, a support piece arranged at the adapter or formed thereby, and a thumb stop that is arranged at and connected in an articulated manner to the support piece. It can here in particular be a thumb rest in accordance with the invention. Provision is made in accordance with the invention that the joint for the connection of the thumb stop to the support piece in an articulated manner is not fixed so that the thumb stop is rotatably supported with respect to the support piece during playing. This use differs from the solutions known from the prior art in which the thumb stop is fixed in its position and orientation for the playing of the wind instrument. To prevent a one-sided playing posture, it is proposed in accordance with the invention to support the thumb stop rotatably with respect to the support piece, in particular also during playing, whereby the position and/or orientation of the thumb stop is also variable during playing. The statements on the thumb rest in accordance with the invention and on the wind instrument in accordance with the invention apply accordingly with respect to further exemplary embodiments.

Advantageous further developments result from the claims, the description, and the drawings. The advantages named in the description of features and of combinations of a plurality of features are only exemplary and can come into effect alternatively or cumulatively without the advantages of embodiments in accordance with the invention necessarily having to be achieved. The features named in the claims and in the description are to be understood with respect to their number such that exactly this number or a larger number than said number is present without this requiring an explicit use of the term “at least”. If therefore, for example, a degree of rotational freedom is spoken of, it is to be understood such that exactly one degree of rotational freedom, two degrees of rotational freedom, or a plurality of degrees of rotational freedom is/are present. These features can be supplemented by other features or can be the only features the respective product consists of. The reference numerals contained in the claims do not represent any restriction of the scope of the subjects protected by the claims. They only serve the purpose of making the claims easier to understand.

### BRIEF DESCRIPTION OF THE DRAWINGS

Further measures improving the invention will be shown in more detail below together with the description of preferred embodiments of the invention with reference to the Figures.

FIG. 1 is a view of a section of a clarinet with a thumb rest arranged thereon;

FIG. 2 is a detail view of a portion of FIG. 1;

FIG. 3 a view of an adapter of the thumb rest in accordance with FIG. 1 and its mounting at the body of the clarinet; and

FIG. 4 is a view of individual parts of the thumb rest in accordance with FIG. 1 in the dismantled and assembled states.

### DETAILED DESCRIPTION OF THE INVENTION

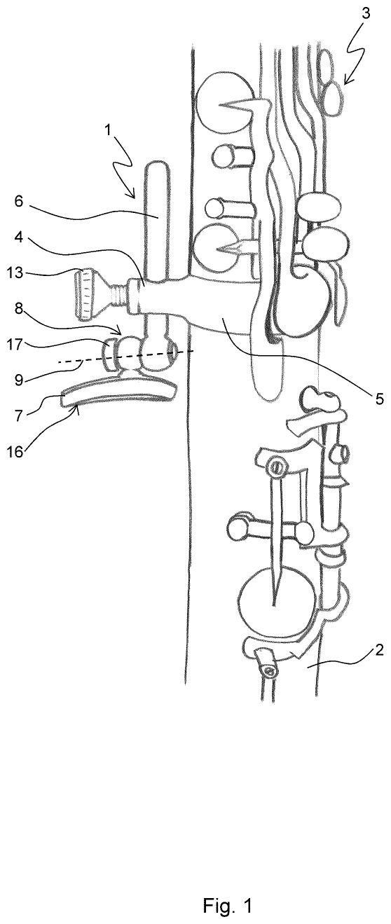

A thumb rest 1 in accordance with the invention is shown in FIGS. 1 to 4 that is fastened to the body 2 of a clarinet 3 in the embodiment shown.

The thumb rest 1 comprises an adapter 4 by which the thumb rest 1 is fastened to the body 2. In the embodiment shown, the adapter 4 is e.g. connected to a metal ring 5 of the body 2 of the clarinet 3 by a soldered connection. A secure fastening of the thumb rest 1 to the clarinet 3 is achieved by this kind of connection that has particularly little influence on the sound forming parts of the clarinet 3.

The thumb rest 1 furthermore comprises a support piece 6 and a thumb stop 7 rotatably arranged with respect to the support piece 6. A joint 8 in the form of a pivot joint having exactly one axis of rotation 9 is provided for the rotatable support here.

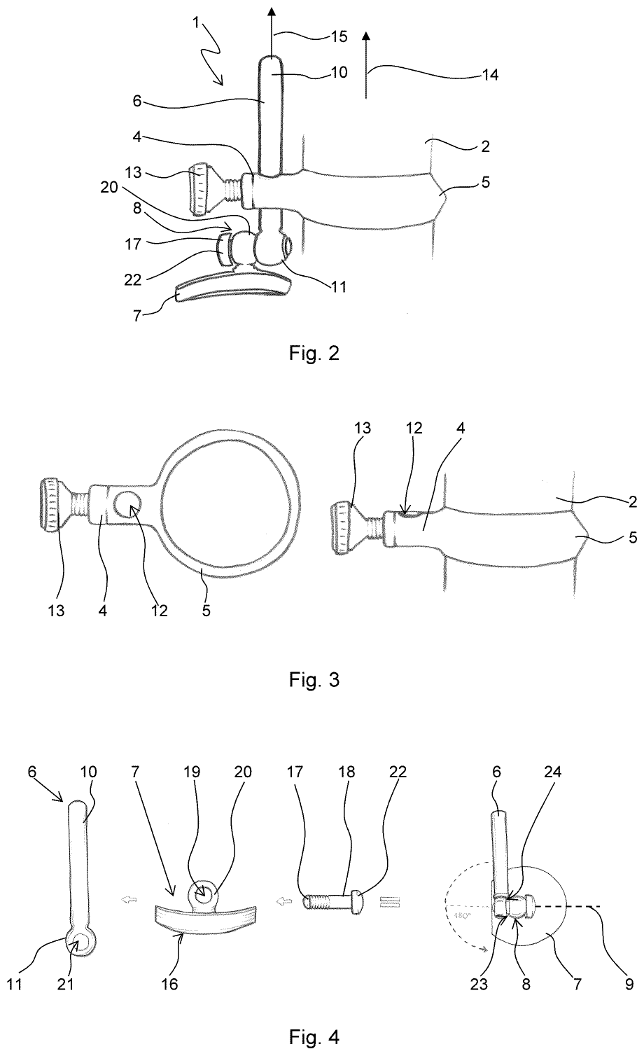

As in particular shown in detail in FIG. 4, the support piece 6 comprises a pin-like section 10 having a circular cross-section and a support section 11 at the end side for the thumb stop 7. The pin-like section 10 serves the arrangement of the support piece 6 at the adapter 4. The adapter 4 specifically has a mount 12 having a free cross-section complementary to the cross-section of the section 10 for this purpose. A screw 13 by which the pin-like section 10 of the support piece 6 can be clampingly fixed in the mount 12 is provided to fix the support piece 6 in the mount 12. If a player wants to set the thumb rest 1 ideally for himself prior to playing, he can release the screw 13. The support piece 6 can be displaced in the released state—as indicated in FIG. 2—in the direction of the longitudinal axis 14 of the body 2 of the clarinet 3 one the one hand. On the other hand, the support piece can also be rotated in the mount about the longitudinal axis 15 of the support piece 6 that is oriented substantially in parallel with the longitudinal axis 14 of the clarinet 3. After the setting of the optimum position and orientation for the player has taken place, he can fix this setting by screwing the screw 13 tight.

The thumb stop 7 has—as is in particular shown in detail in FIG. 4—a contact surface 16 by which the thumb stop 7 lies on the thumb of the player. The contact surface 16 of the thumb stop can be cushioned for a pleasing wearing sensation. A felt or a rubber covering can e.g. be provided for this purpose in the region of the contact surface 16. The contact surface 16 is oriented substantially transversely to the acting weight force of the clarinet 3, whereby the weight of the clarinet 3 can be comfortably supported during playing.

In accordance with the invention, the thumb stop 7 is in particular rotatably supported with respect to the support piece 6 during playing. In the embodiment shown, the joint 8 configured as a pivot joint is provided for the rotatable support. The joint 8 comprises a screw 17. The shaft 18 of the screw 17 extends through a mount 19 in an eye 20 of the thumb stop 8 and its end is screwed into a cutout 21 in the support section 11 of the support piece 6. The thumb stop is thus rotatably supported with respect to the support piece 6 about the shaft 18 of the screw 17 that defines the axis of rotation 9 of the joint 8. The angular range about which the thumb stop 7 is rotatable about the axis of rotation 9 amounts to approximately 180° in the embodiment shown.

The thumb stop 7 is here securely held at the support piece 6 by the head 22 of the screw 17. How tightly the thumb stop 7 is clamped between the support piece 6 and the head 22 of the screw 17 can be set by how far the screw 17 is screwed into the thread in the cutout 21 in the support section 11. I.e. how smoothly the thumb stop 7 is to be rotatable about the axis of rotation 9 can ultimately thereby be set. How tightly the thumb stop 7 can be clamped between the support piece 6 and the head 22 of the screw 17 can e.g. be limited in that a stop at the shaft 18 of the screw 17 is provided up to which it can be screwed into the cutout 21. A fixing of the thumb stop 7 at the support piece 6 can in particular thus be prevented.

The rotational movement is guided, on the one hand, by the shaft 18 of the screw 17 extending through the cutout 19. In addition, the eye 20 is designed, as shown in FIG. 4 as a ball so that a convex support surface 23 is formed. As likewise indicated in FIG. 4, a support surface 24 of the support section 11 corresponding thereto is formed as slightly concave in a complementary manner thereto. A particularly good guidance of the rotational movement can be achieved by the interaction of the two support surfaces 23 and 24 of the thumb stop 7 and the support piece 6 formed complementarily to one another.

### REFERENCE NUMERAL LIST

1 thumb rest
2 body
3 clarinet
4 adapter
5 metal ring
6 support piece
7 thumb stop
8 joint
9 axis of rotation
10 section
11 section
12 mount
13 screw
14 longitudinal axis
15 longitudinal axis
16 support surface
17 screw
18 shaft
19 cutout
20 eye
21 cutout
22 head
23 support surface
24 support surface

1. A thumb rest for a wind instrument, comprising
an adapter to attach the thumb rest to a body of the wind instrument;
a support piece arranged at the adapter or supported thereby; and
a thumb stop arranged at the support piece;
wherein the thumb stop and the support piece are connected to one another in an articulated manner by a joint by which a permanent degree of rotational freedom of the thumb stop with respect to the support piece is provided so that the thumb stop is permanently rotatable with respect to the support piece.

2. The thumb rest in accordance with claim 1, wherein the joint is a pivot joint having exactly one axis of rotation.

3. The thumb rest in accordance with claim 1, wherein an axis of rotation of the joint is oriented radially with respect to a circular cross-section of the body of the wind instrument in the assembled state of the thumb rest at the wind instrument.

4. The thumb rest in accordance with claim 1, wherein the support piece and the thumb stop have support surfaces formed complementarily to one another, with in particular one of the support surfaces being concave and the other of the support surfaces being convex.

5. The thumb rest in accordance with claim 1, wherein the thumb stop has a cutout and the joint has a shaft that extends in or through the cutout so that the thumb stop is rotatably supported about the shaft.

6. The thumb rest in accordance with claim 5, wherein the shaft is formed by the support piece.

7. The thumb rest in accordance with claim 5, wherein the shaft is formed by a screw or by a bolt that is screwed into a corresponding thread in a cutout of the support piece so that the thumb stop is rotatably held between the support piece and a head of the screw or of the bolt about the axis of rotation defined by the shaft.

8. The thumb rest in accordance with claim 1, wherein the joint is configured such that a smooth movement of the rotation of the thumb stop is settable with respect to the support piece.

9. The thumb rest in accordance with claim 1, wherein the adapter is connected to the body of the wind instrument by clamping and/or with material continuity.

10. The thumb rest in accordance with claim 1, wherein the support piece is received displaceably in a direction of a longitudinal axis of the body in a mount (12) formed by the adapter.

11. The thumb rest in accordance with claim 1, wherein:
the mount is formed in the manner of a sleeve having an annular free mount cross-section; and
the support piece is of pin shape with a cross-section complementary to the mount cross-section.

12. The thumb rest in accordance with claim 1, wherein the wind instrument is a clarinet.

13. A wind instrument, comprising:
a body; and
the thumb rest in accordance with claim 1 fastened to the body.

14. The wind instrument in accordance with claim 13, wherein the wind instrument is a clarinet.

15. A method of providing a wind instrument with a thumb rest, comprising:
providing the thumb rest of claim 1;
attaching the thumb rest to the body of the wind instrument with the adapter;
arranging the support piece at the adapter or supporting the support piece by the adapter; and
arranging the thumb stop at the support piece and connecting the thumb stop to the support piece in an articulated manner by the joint;
the joint is not fixed during the playing of the wind instrument so that the thumb stop is rotatably supported with respect to the support piece during playing.
